(19) United States
(12) Patent Application Publication
(10) Pub. No.: US 2025/0028120 A1
(43) Pub. Date: Jan. 23, 2025

(54) OPTICAL SYSTEM PROVIDED WITH ATTENUATING AREA AND METHOD OF PRODUCING THE SAME

(71) Applicant: NALUX CO., LTD., Osaka (JP)

(72) Inventors: Hironori HORIKIRI, Osaka (JP); Kairi MOROZUMI, Osaka (JP); Hisashi MAKI, Osaka (JP); Tetsuya ZENKO, Osaka (JP); Takahiro FUJIOKA, Osaka (JP)

(73) Assignee: NALUX CO., LTD., Osaka (JP)

(21) Appl. No.: 18/904,545

(22) Filed: Oct. 2, 2024

Related U.S. Application Data
(63) Continuation of application No. PCT/JP2022/027075, filed on Jul. 8, 2022.

(51) Int. Cl. G02B 6/32

(52) U.S. Cl. CPC G02B 6/327

(57) ABSTRACT

An optical element for optically connecting a light source and a light receiving element, the optical element being provided with a lens surface for receiving light designed to face the light source, a lens surface for delivering light designed to face the light receiving element and an attenuating area for attenuating a light beam that is incident on the lens surface for receiving light and reaches the lens surface for delivering light, wherein the optical element is further provided with an additional lens surface and a surface for positioning another light source for the additional lens surface and wherein the additional lens surface is designed such that the conjugate point of the intersection of the optical axis of the additional lens surface with a plane containing the surface for positioning lies on a path of the light beam.

### CROSS REFERENCE TO RELATED APPLICATION

This is a Continuation of International Patent Application No. PCT/JP2022/027075 filed Jul. 8, 2022, which designates the U.S. The content of this application is hereby incorporated by reference.

### TECHNICAL FIELD

The present invention relates to an optical system provided with an attenuating area and a method of producing the same.

### BACKGROUND ART

In the field of optical communication optical elements (optical modules) for optically connecting a light source and a light receiving element are used. Some of such optical elements are required to have a desired value of transmittance in order to reduce an amount of light that passes therethrough from the standpoint of safety and other standards. In order to realize a desired value of transmittance, an optical element provided with a film for attenuating intensity of light on a surface through which the light passe (Patent document 1), an optical element provided with an internal portion that is shaped to diverge light (Patent document 2) and the like have been developed.

In order to produce an optical element provided with a film, however, a great number of additional processing steps and a great amount of additional costs are required. In the case of an optical element provided with an internal portion that is shaped to diverge light, additional noises can be generated by the diverged light. Further, by any of both methods, it is not easy to realize a desired value of transmittance in a wide range with a high accuracy.

Thus, an optical element which is used for optically connecting a light source and a light receiving element and can be produced in relatively simple processing steps and by which a desired value of transmittance in a wide range can be realized with a high accuracy has not been developed. Accordingly, there is a need for an optical element which is used for optically connecting a light source and a light receiving element and can be produced in relatively simple processing steps and by which a desired value of transmittance in a wide range can be realized with a high accuracy.

### PRIOR ART DOCUMENT

### Patent Document

Patent document 1: JPH11119063A
Patent document 2: JP2008145678A

The object of the present invention is to provide an optical element which is used for optically connecting a light source and a light receiving element and can be produced in relatively simple processing steps and by which a desired value of transmittance in a wide range can be realized with a high accuracy.

### SUMMARY OF THE INVENTION

An optical element for optically connecting a light source and a light receiving element according to a first aspect of the present invention is provided with a lens surface for receiving light designed to face the light source, a lens surface for delivering light designed to face the light receiving element and an attenuating area for attenuating a light beam that is incident on the lens surface for receiving light and reaches the lens surface for delivering light. The optical element is further provided with an additional lens surface and a surface for positioning another light source for the additional lens surface. The additional lens surface is designed such that the conjugate point of the intersection of the optical axis of the additional lens surface with a plane containing the surface for positioning lies on a path of the light beam.

The attenuating area refers to an area in which attenuation of a light beam that is incident on the lens surface for receiving light and reaches the lens surface for delivering light is greater than in other portions on the path of the light beam. How to form the attenuating area using a laser beam will be described later. The optical axis of a lens surface refers to the central axis of the lens surface that passes through the vertex of the lens surface. When the conjugate point of the intersection of the optical axis of the additional lens surface with a plane containing the surface for positioning lies on a path of the light beam, a laser beam for processing that is incident on the additional lens surface is focused on the conjugate point and optical properties of material around the conjugate point are changed as described later, so that the attenuating area is formed on the path of a light beam that is incident on the lens surface for receiving light and reaches the lens surface for delivering light.

The attenuating area of the optical element according to the present aspect of the invention is formed by making a laser beam enter the optical element through the additional lens surface while observing intensity of a light beam that is incident on the lens surface for receiving light and delivered by the lens surface for delivering light. Accordingly, in the optical element a desired value of transmittance in a wide range has been realized with a high accuracy.

In the optical element according to a first embodiment of the first aspect of the present invention, the attenuating area is an area in which optical properties of material have changed.

In the optical element according to a second embodiment of the first aspect of the present invention, a surface of the optical element, on which the lens surface for receiving light is provided and a surface of the optical element, on which the lens surface for delivering light is provided, are perpendicular to each other and the additional lens surface is provided on the surface of the optical element, on which the lens surface for delivering light is provided.

In the present embodiment, the additional lens surface is provided on the surface of the optical element, on which the lens surface for delivering light is provided. Accordingly, a mold part for molding both lens surfaces can be machined as a single part and therefore accuracy in the center-to-center spacing between both lens surfaces can be improved. Further, since a single ferrule can be used for an optical fiber for processing and an optical fiber for communication, a ferrule positioning mechanism can be simplified. As a result, the cost of production can be reduced. Further, since the ferrule positioning mechanism is provided on the surface on which both lens surfaces are provided, the mold part for molding both lens surfaces and the ferrule positioning mechanism can be machined as a single part and therefore accuracy in aligning an optical fiber for processing and an optical fiber for communication with the optical element can be improved.

In the optical element according to a third embodiment of the first aspect of the present invention, a surface of the optical element, on which the lens surface for receiving light is provided and a surface of the optical element, on which the lens surface for delivering light is provided, are perpendicular to each other and the additional lens surface is provided on the surface of the optical element, on which the lens surface for delivering light is provided.

In the present embodiment, the additional lens surface is provided on the surface of the optical element, on which the lens surface for receiving light is provided. Accordingly, a mold part for molding both lens surfaces can be machined as a single part and therefore accuracy in the center-to-center spacing between both lens surfaces can be improved. Further, an optical fiber is used as a light source for communication when transmittance is measured during a process of producing the attenuating area and therefore the light source for communication can be easily aligned with the optical element.

In the optical element according to a fourth embodiment of the first aspect of the present invention, a surface of the optical element, on which the lens surface for receiving light is provided and a surface of the optical element, on which the lens surface for delivering light is provided, are perpendicular to each other and the additional lens surface is provided on a surface of the optical element other than the surface of the optical element, on which the lens surface for receiving light is provided and the surface of the optical element, on which the lens surface for delivering light is provided.

In the present embodiment, the thickness (the height) of the optical element can be reduced by installing the additional lens surface on a surface of the optical element other than the surface of the optical element, on which the lens surface for receiving light is provided and the surface of the optical element, on which the lens surface for delivering light is provided.

In the optical element according to a fifth embodiment of the first aspect of the present invention, a surface of the optical element, on which the lens surface for receiving light is provided and a surface of the optical element, on which the lens surface for delivering light is provided, are parallel to each other and the additional lens surface is provided on a surface of the optical element other than the surface of the optical element, on which the lens surface for receiving light is provided and the surface of the optical element, on which the lens surface for delivering light is provided.

The optical element according to the present embodiment can be used for an optical fiber that runs in the direction perpendicular to the bottom of the optical element or to a substrate for a light source for communication. Further, an area of the substrate, the area being occupied by the optical element can be reduced by installing the additional lens surface on a surface of the optical element other than the surface of the optical element, on which the lens surface for receiving light is provided and the surface of the optical element, on which the lens surface for delivering light is provided.

In the optical element according to a sixth embodiment of the first aspect of the present invention, a surface of the optical element, on which the lens surface for receiving light is provided and a surface of the optical element, on which the lens surface for delivering light is provided, are parallel to each other and the additional lens surface is provided on the surface of the optical element, on which the lens surface for delivering light is provided.

The optical element according to the present embodiment can be used for an optical fiber that runs in the direction perpendicular to the bottom of the optical element or to a substrate for a light source for communication. Further, the thickness (the height) of the optical element can be reduced.

In the optical element according to a seventh embodiment of the first aspect of the present invention, the surface for positioning is parallel to a surface of the optical element, on which the additional lens surface is provided.

The optical element according to an eighth embodiment of the first aspect of the present invention is designed to substantially collimate the light beam that is incident on the lens surface for receiving light and reaches the lens surface for delivering light.

In the present embodiment, the attenuating area is formed on the path of the substantially collimated light beam and therefore transmittance can be easily adjusted. Accordingly, the optical element with transmittance adjusted with a high accuracy can be obtained.

The optical element according to a ninth embodiment of the first aspect of the present invention is used for a multicore optical fiber and includes lens surfaces for receiving light arranged in a line, lens surfaces for delivering light arranged in a line, additional lens surfaces arranged in a line, the lines being parallel to one other, and a single surface for positioning plural light sources for the additional lens surfaces, wherein one of the lens surfaces for receiving light, one of the lens surfaces for delivering light and one of the additional lens surfaces make a set and the lens surfaces are arranged such that coordinates in the direction of the lines of positions of the lens surfaces in each set are identical with one another, wherein for each set an attenuating area for attenuating a light beam that is incident on the lens surface for receiving light and reaches the lens surface for delivering light is provided and wherein for each set the additional lens surface is designed such that the conjugate point of the intersection of the optical axis of the additional lens surface with a plane containing the surface for positioning lies on a path of the light beam that is incident on the lens surface for receiving light and reaches the lens surface for delivering light.

In the optical element for a multicore optical fiber according to the present embodiment, a desired value of transmittance in a wide range can be realized with a high accuracy.

In a method of producing an optical element for optically connecting a light source and a light receiving element according to a second aspect of the present invention, the optical element includes an attenuating area therein and the method includes: producing an optical element provided with a lens surface for receiving light designed to face the light source, a lens surface for delivering light designed to face the light receiving element and an additional lens surface; and forming the attenuating area inside the optical element by making a laser beam enter the optical element through the additional lens surface based on observation of intensity of a light beam that is incident on the lens surface for receiving light and delivered by the lens surface for delivering light such that a desired value of transmittance of the optical element for the light beam is realized by the attenuating area.

In the method of producing an optical element according to the present aspect, the attenuating area of the optical element is formed by making a laser beam pass through the additional lens surface based on observation of intensity of a light beam that is incident on the lens surface for receiving light and delivered by the lens surface for delivering light. Accordingly, an optical element with a desired value of transmittance in a wide range realized with a high accuracy can be easily produced.

In the method of producing an optical element according to a first embodiment of the second aspect of the present invention, the optical element is used for a multicore optical fiber and includes lens surfaces for receiving light arranged in a line, lens surfaces for delivering light arranged in a line, additional lens surfaces arranged in a line, the lines being parallel to one other, and a single surface for positioning plural light sources for the additional lens surfaces and one of the lens surfaces for receiving light, one of the lens surfaces for delivering light and one of the additional lens surfaces make a set and the lens surfaces are arranged such that coordinates in the direction of the lines of positions of the lens surfaces in each set are identical with one another.

According to the present embodiment, an optical element with a desired value of transmittance in a wide range realized with a high accuracy can be easily produced.

### BRIEF DESCRIPTION OF DRAWINGS

FIG. 1 shows a configuration of a system for forming an attenuating area in the optical element;

FIG. 2 is a flowchart for describing how to produce the optical element;

FIG. 3 is a perspective view of the optical element of Example 1 from above;

FIG. 4 is a perspective view of the optical element of Example 1 from below;

FIG. 5 is a top view of the optical element of Example 1 equipped with a ferrule;

FIG. 6 shows the A-A cross section in FIG. 5;

FIG. 7 shows the B-B cross section in FIG. 5;

FIG. 8 is an enlarged view of the portion marked with C in FIG. 6;

FIG. 9 is an enlarged view of the portion marked with D in FIG. 7;

FIG. 10 shows paths of rays of light that are incident on the lens surface for receiving light and reach the lens surface for delivering light;

FIG. 11 is a perspective view of the optical element of Example 1 from above;

FIG. 12 is a perspective view of the optical element of Example 2 from below;

FIG. 13 is a top view of the optical element of Example 2 equipped with a ferrule;

FIG. 14 shows the A-A cross section in FIG. 13;

FIG. 15 shows the B-B cross section in FIG. 13;

FIG. 16 is an enlarged view of the portion marked with C in FIG. 14;

FIG. 17 is an enlarged view of the portion marked with D in FIG. 15;

FIG. 18 shows paths of rays of light that are incident on the lens surface for receiving light and reach the lens surface 131 for delivering light;

FIG. 19 is a perspective view of the optical element of Example 3 from above;

FIG. 20 is a perspective view of the optical element of Example 3 from below;

FIG. 21 is a top view of the optical element of Example 3 equipped with two ferrules;

FIG. 22 shows the A-A cross section in FIG. 21;

FIG. 23 shows the B-B cross section in FIG. 21;

FIG. 24 is a side view of the optical element of Example 3 equipped with two ferrules;

FIG. 25 is a perspective view of the optical element of Example 4 from above;

FIG. 26 is a perspective view of the optical element of Example 4 from below;

FIG. 27 is a top view of the optical element of Example 4 equipped with a ferrule;

FIG. 28 shows the A-A cross section in FIG. 27;

FIG. 29 shows the B-B cross section in FIG. 27;

FIG. 30 is a side view of the optical element of Example 4 equipped with two ferrules;

FIG. 31 is a perspective view of the optical element of Example 5 from above;

FIG. 32 is a perspective view of the optical element of Example 5 from below;

FIG. 33 is a plane cross section of the optical element of Example 5 equipped with two ferrules;

FIG. 34 shows the A-A cross section in FIG. 33;

FIG. 35 is a cross section of the optical element of Example 5 equipped with two ferrules;

FIG. 36 shows the B-B cross section in FIG. 33;

FIG. 37 is a top view of the optical element 100 of Example 5 equipped with two ferrules;

FIG. 38 is a side view of the optical element 100 of Example 5 equipped with two ferrules;

FIG. 39 is a perspective view of the optical element of Example 6 from above;

FIG. 40 is a perspective view of the optical element of Example 6 from below;

FIG. 41 is a top view of the optical element of Example 6;

FIG. 42 is a side view of the optical element of Example 6;

FIG. 43 is a bottom view of the optical element of Example 6;

FIG. 44 is a top view of the optical element 100 of Example 5 equipped with two ferrules;

FIG. 45 shows the A-A cross section in FIG. 44;

FIG. 46 shows the B-B cross section in FIG. 44;]

FIG. 47 is an enlarged view of the portion marked with C in FIG. 45;

FIG. 48 is an enlarged view of the portion marked with E in FIG. 46;

FIG. 49 is a top view of the optical element of Example 5 equipped with two ferrules;

FIG. 50 is a perspective view of the optical element of Example 7 from above;

FIG. 51 is a perspective view of the optical element of Example 7 from below;

FIG. 52 is a top view of the optical element of Example 7;

FIG. 53 is a side view of the optical element of Example 7;

FIG. 54 is a bottom view of the optical element of Example 7;

FIG. 55 is a side view of the optical element of Example 7 equipped with a ferrule;

FIG. 56 shows the A-A cross section in FIG. 55;

FIG. 57 shows the B-B cross section in FIG. 55;

FIG. 58 is an enlarged view of the portion marked with C in FIG. 56;

FIG. 59 is an enlarged view of the portion marked with D in FIG. 57; and

FIG. 60 is a perspective view of the optical element 100 of Example 7 equipped with a ferrule.

### DESCRIPTION OF EMBODIMENTS

An optical element 100 according to an embodiment of the present invention is designed to optically connect a light source and a light receiving element. When the optical element 100 is used for transmitting signals, by way of example, the light source is a semiconductor optical element such as a VCSEL (Vertical Cavity Surface Emitting LASER) and the light receiving element is an optical fiber. When the optical element 100 is used for receiving signals, by way of example, the light source is an optical fiber and the light receiving element is a semiconductor optical element such as a photodiode.

FIG. 9 shows a cross section of the optical element 100 according to an embodiment of the present invention, the cross section containing the central axes of a lens surface 111 for receiving light and a lens surface 131 for delivering light.

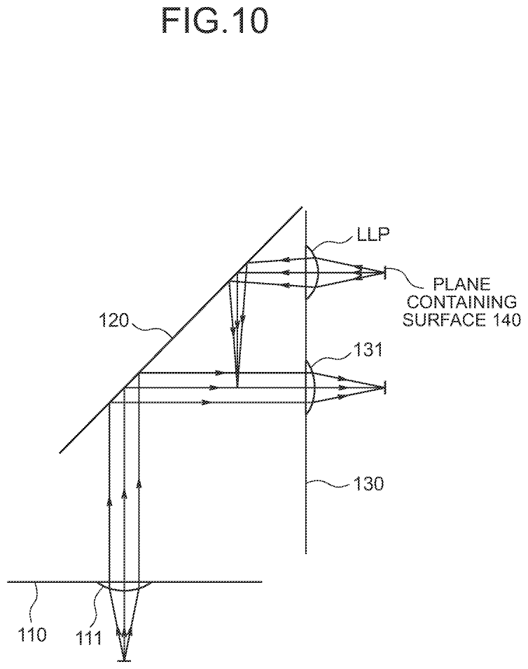

FIG. 10 shows paths of rays of light that are incident on the lens surface 111 for receiving light and reach the lens surface 131 for delivering light.

FIG. 9 and FIG. 10 illustrate Example 1 that will be described later. As shown in FIGS. 9 and 10, a light beam emitted by a light source 410 are substantially collimated by the lens surface 111 for receiving light provided on a surface 110 of the optical element 100 and travels in the optical element 100. The substantially collimated light beam is reflected by a surface 120 of the optical element 100 and then reaches the lens surface 131 for delivering light provided on a surface 130 of the optical element 100. The substantially collimated light beam is focused on the end face of an optical fiber 310 for communication. In this way, the optical element 100 optically connects the light source 410 and the optical fiber 310 for communication.

On the surface 130 of the optical element 100, an additional lens surface LLP for laser processing is provided. The additional lens surface LLP receives a laser beam from an optical fiber 320 for processing. The additional lens surface LLP is designed to focus the laser beam received from the optical fiber 320 for processing on or in the vicinity of paths of rays of light that are incident on the lens surface 111 for receiving light and reach the lens surface 131 for delivering light. The optical fiber 310 for communication and the optical fiber 320 for processing are aligned by a ferrule (an optical connector) 200 respectively with the lens surface 131 for delivering light and the additional lens surface LLP.

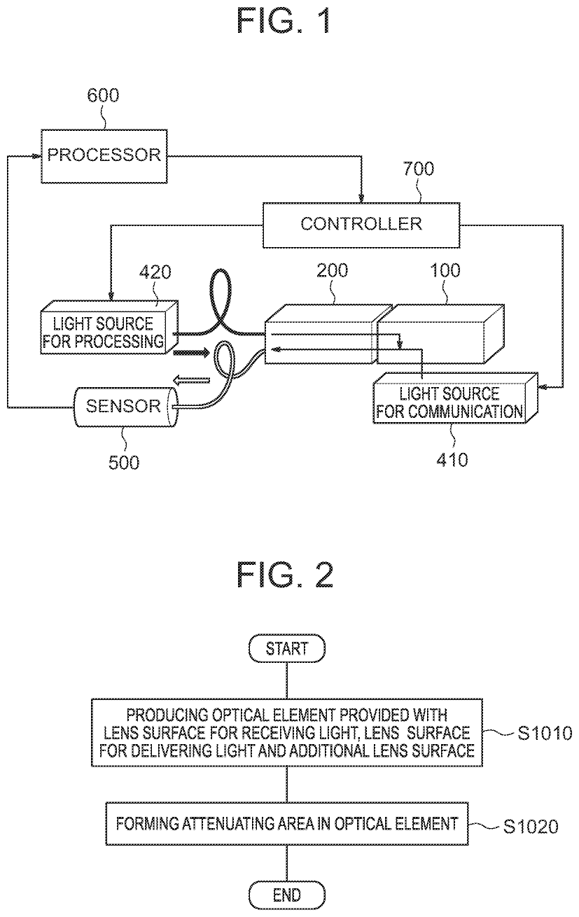

FIG. 1 shows a configuration of a system for forming an attenuating area in the optical element 100. The attenuating area refers to an area in which attenuation of a light beam that is incident on the lens surface 111 for receiving light and reaches the lens surface 131 for delivering light is greater than in other portions on the path of the light beam. The material of the optical element 100 should preferably be plastic such as PEI (Polyetherimid), PI (Polyimid) and PESU (PES) (Polyether Sulfone). The lens surface 111 for receiving light of the optical element 100 is optically connected to the light source 410 for communication such as a VCSEL (Vertical Cavity Surface Emitting LASER). The lens surface 131 for delivering light of the optical element 100 is optically connected to a sensor 500 such as an optical power meter through the optical fiber 310 for communication, and the additional lens surface LLP of the optical element 100 is optically connected to a light source 420 for processing through the optical fiber 320. The light source 420 for processing is a fiber laser, an ultrashort pulse laser or the like. By way of example, the power of a fiber laser is in a range between 20 kW and 70 kW. The optical fiber 310 and the optical fiber 320 are aligned by the optical connector 200 respectively with the lens surface 131 for delivering light and the additional lens surface LLP. The output of the sensor 500 is connected to the input of a processor 600, the output of the processor 600 is connected to the input of a controller 700 and the output of the controller 700 is connected to the light source 410 for communication and the source 420 for processing. The system is configured such that the processor 600 sends a set point for the output of the light source 420 for processing and the like, the set point having been obtained based on the output of the sensor 500, to the controller 700 and the controller 700 controls the outputs of the light source 410 for communication and the light source 420 for processing based on the set point from the processor 600.

FIG. 2 is a flowchart for describing how to produce the optical element 100.

In step S1010 of FIG. 2, an optical element provided with a lens surface 111 for receiving light that is designed to face a light source, a lens surface 131 for delivering light that is designed to face a light receiving element and an additional lens surface LLP is produced.

In step S1020 of FIG. 2, an attenuating area is formed in the optical element. More specifically, a laser beam is made to enter the additional lens surface LLP through the optical fiber 320 while a light beam is incident on the lens surface 111 for receiving light and the intensity of the light delivered from the lens surface 131 for delivering light is monitored using the sensor 500. In an area around the point on which the laser beam is focused by the additional lens surface LLP, the laser beam causes a change in refractive index or an increase in absorption of the material. When the above-described area in which optical properties of the material have changed overlaps the path of the light beam that is incident on the lens surface 111 for receiving light and reaches the lens surface 131 for delivering light, a portion of the light that is incident on the lens surface 111 for receiving light and travels to the lens surface 131 for delivering light is scattered and/or absorbed there and an amount of the light that is incident on the lens surface 111 for receiving light and reaches the lens surface 131 for delivering light is reduced. Intensity of light delivered from the lens surface 131 for delivering light is observed by the sensor 500 while a light beam is incident on the lens surface 111 for receiving light and a laser beam is incident on the additional lens surface LLP, and based on the observed values at least one of intensity and time of irradiation of the laser beam is controlled by the processor 600 through the controller 700. Thus, an attenuating area for a light beam that is incident on the lens surface 111 for receiving light and delivered from the lens surface 131 for delivering light, the attenuating area having a desired value of transmittance, can be formed around the point on which a laser beam is focused by the additional lens surface LLP.

When the optical element 100 is designed for connection of a multicore optical fiber, the control can be carried out for each set of a lens surface 111 for receiving light, a lens surface 131 for delivering light and an additional lens surface LLP, the set being used for one optical fiber for communication. Alternatively, power of laser beams that are incident on plural or all additional lens surfaces LLP can be controlled based on observed values of intensity of light delivered by a single lens surface 131 for delivering light. The observed values are obtained by the sensor 500

In general, the point on which a laser beam is focused by the additional lens surface LLP should preferably be located on the path of the principal ray of a light beam that is incident on the lens surface 111 for receiving light and reaches the lens surface 131 for delivering light, that is, on the path of the ray that passes through the vertex of the lens surface 111 for receiving light and the vertex of the lens surface 131 for delivering light. The reason is that by forming an attenuating area such that the center of the area is located at a position where an intensity distribution of the light beam for communication that is incident on the lens surface 111 for receiving light and reaches the lens surface 131 for delivering light shows the peak in a cross section perpendicular to the travelling direction of the light beam, influence of an unintended change in the focal point of a laser beam for processing that is incident on the additional lens surface LLP can be reduced. On the other hand, the point on which a laser beam is focused by the additional lens surface LLP can be located away from the above-described path in order to realize an attenuating area with transmittance of a desired value.

In this way, an attenuating area with transmittance of any desired value between 0% and 100% can be formed by appropriately determining intensity of the laser beam, time of irradiation of the laser beam and the position of the point on which the laser beam is focused by the additional lens surface LLP. Typically, a desired value of transmittance in optical communication is in a range between 90% and 25.5% (a ratio of intensity of the delivered light to intensity of the incident light is between −0.5 dB and −6.0 dB).

Examples of the present invention will be described below. The same reference letter is used for components corresponding to one another in all examples. The material of the optical element in the examples is polyetherimid (PEI) and refractive index at the wavelength of 850 nanometers is 1.638.

### Example 1

The optical element 100 of Example 1 is designed for connection in a single procedure of a multicore optical fiber and used with a MT ferrule (Mechanically Transferable Ferrule) used for connection in a single procedure.

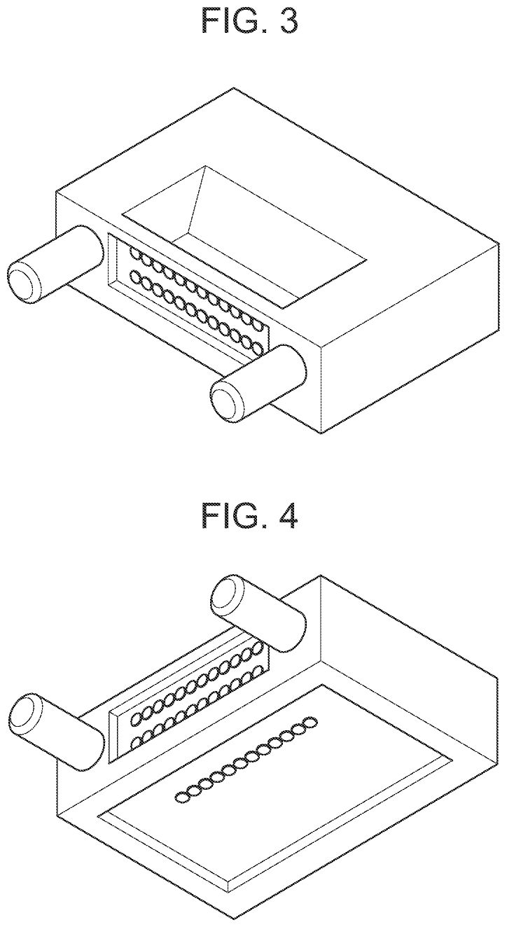

FIG. 3 is a perspective view of the optical element 100 of Example 1 from above.

On a side of the optical element 100, each of a set of 12 additional lens surfaces LLP and a set of 12 lens surfaces 131 for delivering light is arranged in a line. The two lines are parallel to each other. The diameter of each additional lens surface LLP and each lens surface 131 for delivering light is 250 micrometers. Each of the center-to-center spacing between two adjacent additional lens surfaces LLP and the center-to-center spacing between two adjacent lens surfaces 131 for delivering light is 250 micrometers. One of the additional lens surfaces LLP and one of the lens surfaces 131 for delivering light make a set. The lens surfaces are arranged such that the coordinates in the direction of the above-described lines of the positions of the additional lens surface LLP and the lens surface 131 for delivering light in each set are identical with each other. The center-to-center spacing between the additional lens surface LLP and the lens surface 131 for delivering light in each set is 500 micrometers.

FIG. 4 is a perspective view of the optical element 100 of Example 1 from below.

On the bottom of the optical element 100, a set of 12 lens surfaces 111 for receiving light is arranged in a line. The line of the lens surfaces 111 for receiving light is parallel to the line of the additional lens surfaces LLP and the line of the lens surfaces 131 for delivering light. The diameter of each lens surface 111 for receiving light is 250 micrometers. The center-to-center spacing between two adjacent lens surfaces 111 for receiving light is 250 micrometers. One of the lens surfaces 111 for receiving light, one of the lens surfaces 131 for delivering light and one of the additional lens surfaces LLP make a set. The lens surfaces are arranged such that the coordinates in the direction of the above-described lines of the positions of the three lens surfaces in each set are identical with one another. The lens surface 111 for receiving light and the lens surface 131 for delivering light in each set make up an optical system for communication and the additional lens surface LLP in the set makes up an optical system for forming an attenuating area for the above-described optical system for communication.

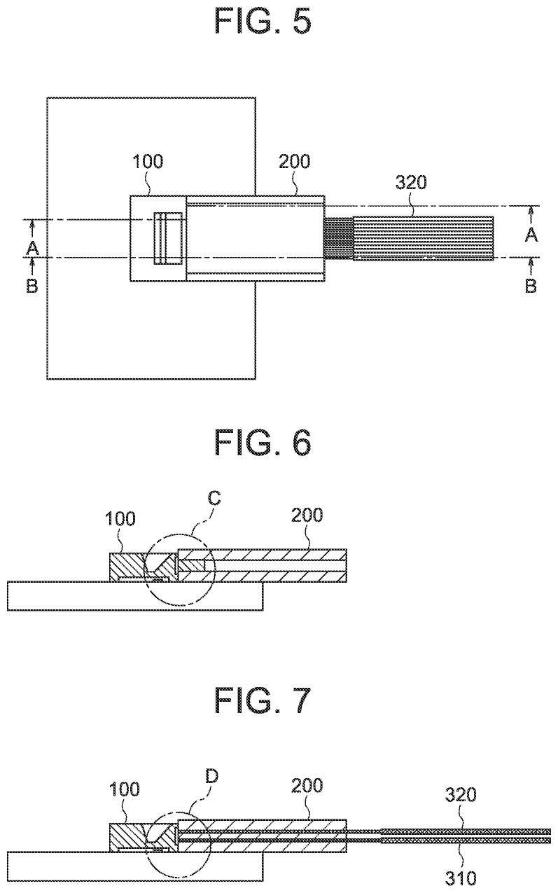

FIG. 5 is a top view of the optical element 100 of Example 1 equipped with a ferrule 200.

FIG. 6 shows the A-A cross section in FIG. 5.

FIG. 7 shows the B-B cross section in FIG. 5.

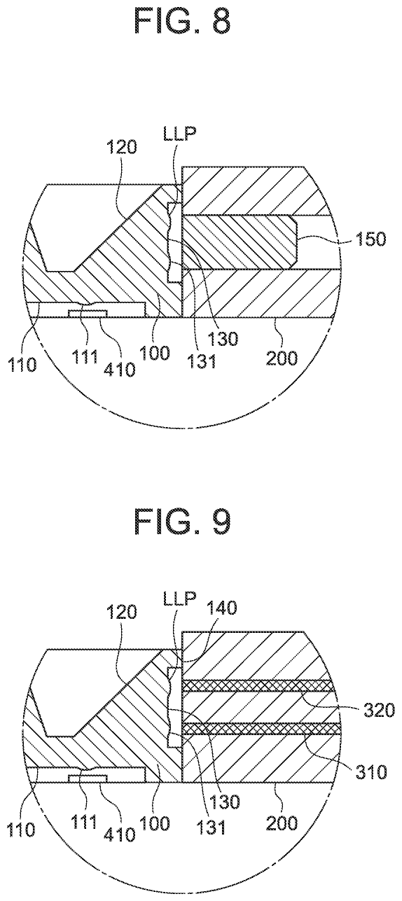

FIG. 8 is an enlarged view of the portion marked with C in FIG. 6. The ferrule 200 is fixed to the optical element 100 by inserting a pin 150 for fixing a ferrule of the optical element 100 into a hole of the ferrule 200.

FIG. 9 is an enlarged view of the portion marked with D in FIG. 7. The lens surface 111 for receiving light, the lens surface 131 for delivering light and the additional lens surface LLP shown in FIG. 9 are contained in a single set. The lens surface 111 for receiving light receives a light beam from a light source 410. The lens surface 131 for delivering light focuses the light beam on the end face of an optical fiber 310 for communication. The additional lens surface LLP receives a laser beam from an optical fiber 320 for processing. The optical fiber 310 for communication and the optical fiber 320 for processing are positioned using a surface 140 for positioning. A surface140 for positioning is parallel to a surface 130 on which the additional lens surface LLP and the lens surface 131 for delivering light are provided.

FIG. 10 shows paths of rays of light that are incident on the lens surface 111 for receiving light and reach the lens surface 131 for delivering light. Both the rays of light beam that are incident on the lens surface 111 for receiving light and the rays of laser beam that are incident on the additional lens surface LLP undergo total internal reflection on the surface 120. A distance between the lens surface 131 for delivering light and the surface 120 along the ray that reaches the vertex of the lens surface 131 for delivering light is greater than a distance between the additional lens surface LLP and the surface 120 along the ray that passes through the vertex of the additional lens surface LLP and reaches the surface 120. The surface 120 is inclined by 45 degrees with respect to each of the path of the ray that passes through the vertex of the lens surface 111 for receiving light and reaches the surface 120 and the path of the ray that is reflected on the surface 120 and passes through the vertex of the lens surface 131 for delivering light.

As shown in FIG. 10, the additional lens surface LLP focuses a laser beam that is incident on the additional lens surface LLP on a point on the path of the ray that passes through the vertex of the lens surface 111 for receiving light and the vertex of the lens surface 131 for delivering light. Concerning the additional lens surface LLP, the conjugate point of the intersection of the optical axis of the additional lens surface LLP and the plane containing the surface 140 for positioning (the plane that agrees with the surface 140) is located on the path of the ray that passes through the vertex of the lens surface 111 for receiving light and the vertex of the lens surface 131 for delivering light.

Table 1 shows data of the optical system for communication made up by the lens surface 111 for receiving light and the lens surface 131 for delivering light.

TABLE 1

| | | | | | Distance |
|---|---|---|---|---|---|
| | | Radius of | Conic | | between |
| | Shape of | curvature | constant | Diameter | surfaces |
| | surface | 1/c [mm] | k | D [mm] | t[mm] |
| Light source | Flat | — | — | 0.010 | 0.316 |
| Lens surface | Aspherical | 0.201 | −2.683 | 0.250 | 0.859 |
| 111 for | | | | | |
| receiving light | | | | | |
| Surface 120 for | Flat | — | — | — | 0.825 |
| total reflection | | | | | |
| lens surface | Aspherical | −0.201 | −2.683 | 0.250 | 0.316 |
| 131 for | | | | | |
| delivering light | | | | | |
| Light receiving | Flat | — | — | 0.050 | — |
| element | | | | | |

The shape of each of the lens surface 111 for receiving light and the lens surface 131 for delivering light is aspherical and the sag of each lens surface, that is, a distance in the direction of the optical axis between the vertex and a point on the surface, can be expressed by the following expression. The optical axis agrees with the path of the ray that passes through the vertex of the lens surface 111 for receiving light and the vertex of the lens surface 131 for delivering light.

$$sag = \frac{{cr}^{2}}{1 + \sqrt{1 - ( 1 + k ) {c}^{2} {r}^{2}}} \qquad ( 1 )$$

where
c: curvature (inverse number of radius of curvature)
r: distance from the optical axis
k: conic constant
c is defined such that the value is positive when the lens surface is convex toward the object side and is negative when the lens surface is convex toward the image side.

In Table 1 the numerical data of radius of curvature and conic constant are those for the lens surface 111 for receiving light and the lens surface 131 for delivering light and the numerical data of diameter are those for the light source, the lens surface 111 for receiving light and the lens surface 131 for delivering light.

In Table 1 the “distance between surfaces” of the light source is a distance along the optical axis between the light source and the lens surface 111 for receiving light, the “distance between surfaces” of the lens surface 111 for receiving light is a distance along the optical axis between the lens surface 111 for receiving light and the surface 120 for total internal reflection, the “distance between surfaces” of the surface 120 for total internal reflection is a distance along the optical axis between the surface 120 for total internal reflection and the lens surface 131 for delivering light and the “distance between surfaces” of the lens surface 131 for delivering light is a distance along the optical axis between the lens surface 131 for delivering light and the optical fiber 310 for optical communication.

Table 2 shows data of the optical system for processing made up by the additional lens surface LLP.

TABLE 2

| | | Radius of | | | Diam- | Distance |
|---|---|---|---|---|---|---|
| | | curvature | Conic | Focal | eter | between |
| | Shape of | 1/c | constant | length | D | surfaces |
| | surface | [mm] | k | [mm] | [mm] | t[mm] |
| Light | Flat | — | — | | 0.050 | 0.292 |
| source | | | | | | |
| Additional | Aspherical | 0.119 | −1.495 | | 0.250 | 0.349 |
| lens | | | | | | |
| surface | | | | | | |
| LLP | | | | | | |
| Surface | Flat | — | — | | — | 0.500 |
| 120 for | | | | | | |
| total | | | | | | |
| internal | | | | | | |
| reflection | | | | | | |

The shape of the additional lens surface LLP is aspherical and can be expressed by Expression (1) described above. The optical axis of the optical system made up by the additional lens surface LLP is the path of the ray that passes through the vertex of the additional lens surface LLP and the center of the end face of the optical fiber 320 for processing.

In Table 2 the numerical data of radius of curvature, conic constant and focal length are those of the additional lens surface LLP and the numerical data of diameter are those of the light source and the additional lens surface LLP.

In Table 2 the “distance between surfaces” of the light source is a distance along the optical axis between the optical fiber 320 for a laser beam and the additional lens surface LLP and “distance between surfaces” of the additional lens surface LLP is a distance along the optical axis between the additional lens surface LLP and the surface 120 for total internal reflection and “distance between surfaces” of the surface 120 for total internal reflection is a distance along the optical axis between the surface 120 for total internal reflection and the point on which the additional lens surface LLP focuses the laser beam.

### Example 2

The optical element 100 of Example 2 is designed for connection in a single procedure of a multicore optical fiber and used with a MT ferrule (Mechanically Transferable Ferrule) used for connection in a single procedure.

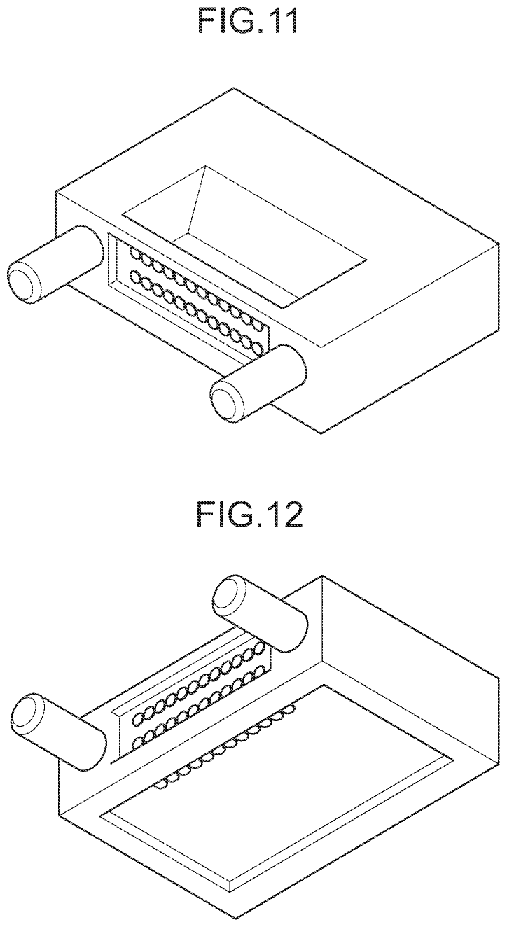

FIG. 11 is a perspective view of the optical element 100 of Example 2 from above.

On a side of the optical element 100, each of a set of 12 lens surfaces 131 for delivering light and a set of 12 additional lens surfaces LLP is arranged in a line. The two lines are parallel to each other. The diameter of each lens surface 131 for delivering light and each additional lens surface LLP is 250 micrometers. Each of the center-to-center spacing between two adjacent lens surfaces 131 for delivering light and the center-to-center spacing between two adjacent additional lens surfaces LLP is 250 micrometers. One of the additional lens surfaces LLP and one of the lens surfaces 131 for delivering light make a set. The lens surfaces are arranged such that the coordinates in the direction of the above-described lines of the positions of the additional lens surface LLP and the lens surface 131 for delivering light in each set are identical with each other. The center-to-center spacing between the additional lens surface LLP and the lens surface 131 for delivering light in each set is 500 micrometers.

FIG. 12 is a perspective view of the optical element 100 of Example 2 from below.

On the bottom of the optical element 100, a set of 12 lens surfaces 111 for receiving light is arranged in a line. The line of the lens surfaces 111 for receiving light is parallel to the line of the additional lens surfaces LLP and the line of the lens surfaces 131 for delivering light. The diameter of each lens surface 111 for receiving light is 250 receiving light is 250 micrometers. One of the lens surfaces 111 for receiving light, one of the lens surfaces 131 for delivering light and one of the additional lens surfaces LLP make a set. The lens surfaces are arranged such that the coordinates in the direction of the above-described lines of the positions of the three lens surfaces in each set are identical with one another. The lens surface 111 for receiving light and the lens surface 131 for delivering light in each set make up an optical system for communication and the additional lens surface LLP in the set makes up an optical system for forming an attenuating area for the above-described optical system for communication.

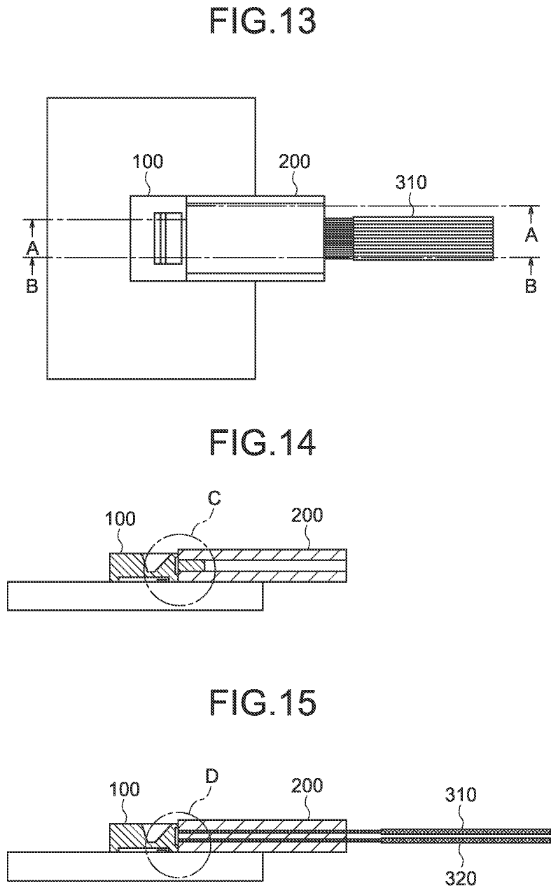

FIG. 13 is a top view of the optical element 100 of Example 2 equipped with a ferrule 200.

FIG. 14 shows the A-A cross section in FIG. 13.

FIG. 15 shows the B-B cross section in FIG. 13.

FIG. 16 is an enlarged view of the portion marked with C in FIG. 14. The ferrule 200 is fixed to the optical element 100 by inserting a pin 150 for fixing a ferrule of the optical element 100 into a hole of the ferrule 200.

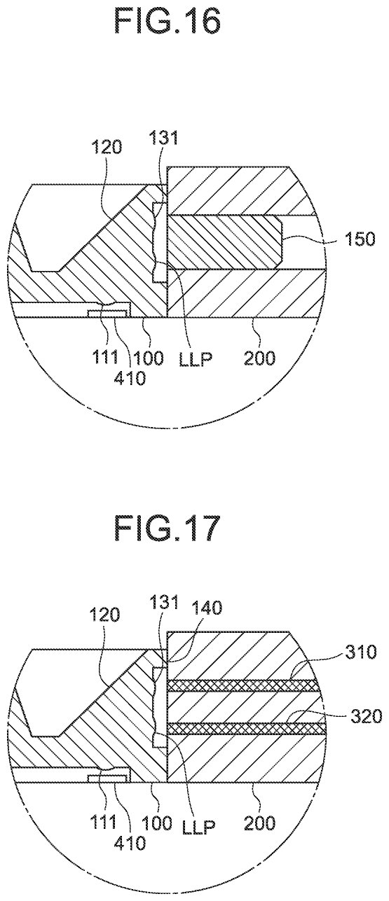

FIG. 17 is an enlarged view of the portion marked with D in FIG. 15. The lens surface 111 for receiving light, the lens surface 131 for delivering light and the additional lens surface LLP shown in FIG. 17 are contained in a single set. The lens surface 111 for receiving light receives a light beam from a light source 410. The lens surface 131 for delivering light focuses the light beam on the end face of an optical fiber 310 for communication. The additional lens surface LLP receives a laser beam from an optical fiber 320 for processing. The optical fiber 310 for communication and the optical fiber 320 for processing are positioned using a surface 140 for positioning. The surface 140 for positioning is parallel to a surface 130 on which the additional lens surface LLP and the lens surface 131 for delivering light are provided.

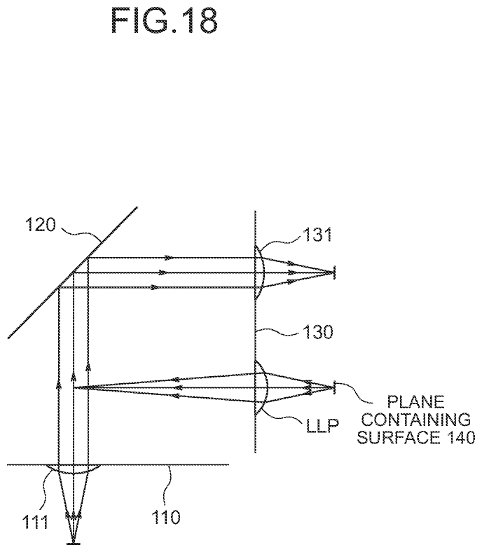

FIG. 18 shows paths of rays of light that are incident on the lens surface 111 for receiving light and reach the lens surface 131 for delivering light. Rays of light beam that are incident on the lens surface 111 for receiving light undergoes total internal reflection on the surface 120. A distance between the lens surface 131 for delivering light and the surface 120 along the ray that reaches the vertex of the lens surface 131 for delivering light is smaller than a distance between the additional lens surface LLP and the surface 120 along a straight line that agrees with the path of the ray that passes through the vertex of the additional lens surface LLP and travels toward the surface 120. The surface 120 is inclined by 45 degrees with respect to each of the path of the ray that passes through the vertex of the lens surface 111 for receiving light and reaches the surface 120 and the path of the ray that is reflected on the surface 120 and passes through the vertex of the lens surface 131 for delivering light.

The data of the optical system for communication made up by the lens surface 111 for receiving light and the lens surface 131 for delivering light are identical with those of Example 1.

As shown in FIG. 18, the additional lens surface LLP focuses a leaser beam that is incident on the additional lens surface LLP on a point on the path of the ray that passes through the vertex of the lens surface 111 for receiving light and the vertex of the lens surface 131 for delivering light. Concerning the additional lens surface LLP, the conjugate point of the intersection of the optical axis of the additional lens surface LLP and the plane containing the surface 140 for positioning (the plane that agrees with the surface 140) is located on the path of the ray that passes through the vertex of the lens surface 111 for receiving light and the vertex of the lens surface 131 for delivering light.

Table 3 shows data of the optical system for processing made up by the additional lens surface LLP.

TABLE 3

| | | Radius of | | | Diam- | Distance |
|---|---|---|---|---|---|---|
| | | curvature | Conic | Focal | eter | between |
| | Shape of | 1/c | constant | length | D | surfaces |
| | surface | [mm] | k | [mm] | [mm] | t[mm] |
| Light | Flat | — | — | | 0.050 | 0.292 |
| source | | | | | | |
| Additional | Aspherical | 0.119 | −1.495 | | 0.250 | 0.849 |
| lens | | | | | | |
| surface | | | | | | |
| LLP | | | | | | |

The shape of the additional lens surface LLP is aspherical and can be expressed by Expression (1) described above. The optical axis of the optical system made up by the additional lens surface LLP agrees with the path of the ray that passes through the vertex of the additional lens surface LLP and the center of the end face of the optical fiber 320 for processing.

In Table 3 the numerical data of radius of curvature, conic constant and focal length are those of the additional lens surface LLP and the numerical data of diameter are those of the light source and the additional lens surface LLP.

In Table 3 the “distance between surfaces” of the light source is a distance along the optical axis between the light source of laser and the additional lens surface LLP and the “distance between surfaces” of the additional lens surface LLP is a distance along the optical axis between the additional lens surface LLP and the point on which the additional lens surface LLP focuses the laser beam.

### Example 3

The optical element 100 of Example 3 is designed for connection in a single procedure of a multicore optical fiber and used with a MT ferrule (Mechanically Transferable Ferrule) used for connection in a single procedure.

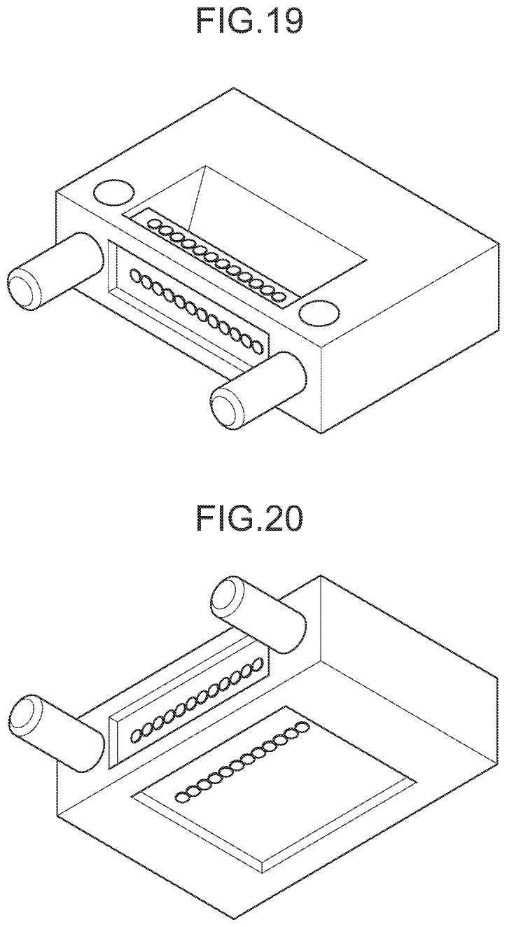

FIG. 19 is a perspective view of the optical element 100 of Example 3 from above.

On a side of the optical element 100, a set of 12 lens surfaces 131 for delivering light is arranged in a line. The diameter of each lens surface 131 for delivering light is 250 micrometers. The center-to-center spacing between two adjacent lens surfaces 131 for delivering light is 250 micrometers. On the top of the optical element 100, a set of 12 additional lens surfaces LLP is arranged in a line such that the line is parallel to the above-described line of the lens surfaces 130 for delivering light. The diameter of each additional lens surface LLP is 250 micrometers. The center-to-center spacing between two adjacent additional lens surfaces LLP is 250 micrometers.

FIG. 20 is a perspective view of the optical element 100 of Example 3 from below.

On the bottom of the optical element 100, a set of 12 lens surfaces 111 for receiving light is arranged in a line such that the line is parrel to the above-described line of the lens surfaces 131 for delivering light. The diameter of each lens surface 111 for receiving light is 250 micrometers. The center-to-center spacing between two adjacent lens surfaces 111 for receiving light is 250 micrometers. One of the lens surfaces 111 for receiving light, one of the lens surfaces 131 for delivering light and one of the additional lens surfaces LLP make a set. The lens surfaces are arranged such that the coordinates in the direction of the above-described lines of the positions of the three lens surfaces in each set are identical with one another. The lens surface 111 for receiving light and the lens surface 131 for delivering light in each set make up an optical system for communication and the additional lens surface LLP in the set makes up an optical system for forming an attenuating area for the above-described optical system for communication.

FIG. 21 is a top view of the optical element 100 of Example 3 equipped with a ferrule 200 and a ferrule 220.

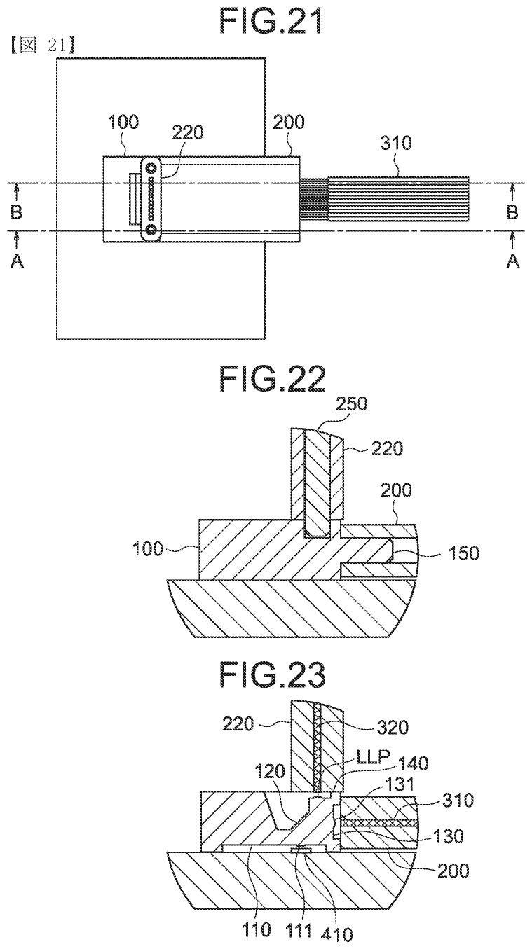

FIG. 22 shows the A-A cross section in FIG. 21. As shown in FIG. 22, the ferrule 200 is fixed to the optical element 100 by inserting a pin 150 for fixing a ferrule of the optical element 100 into a hole of the ferrule 200 and the ferrule 220 is fixed to the optical element 100 by a pin 250 for fixing a ferrule. The pin 250 is separate from other elements and is designed to be inserted into a hole of the ferrule 220 as well as a hole of the optical element 100.

FIG. 23 shows the B-B cross section in FIG. 21. The lens surface 111 for receiving light, the lens surface 131 for delivering light and the additional lens surface LLP shown in FIG. 23 are contained in a single set. The lens surface 111 for receiving light receives a light beam from a light source 410. The lens surface 131 for delivering light focuses the light beam on the end face of an optical fiber 310 for communication. The additional lens surface LLP receives a laser beam from an optical fiber 320 for processing. The optical fiber 320 for processing is positioned using a surface 140 for positioning. The surface 140 for positioning is parallel to a surface on which the additional lens surface LLP is provided.

The optical system for communication made up by the lens surface 111 for receiving light and the lens surface 131 for delivering light is identical with that of Example 1. The additional lens surface LLP focuses a laser beam that is incident on the additional lens surface LLP on a point on the path of the ray that passes through the vertex of the lens surface 111 for receiving light and the vertex of the lens surface 131 for delivering light.

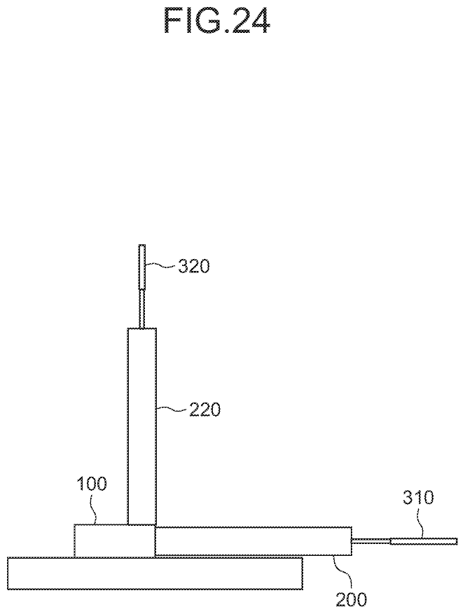

FIG. 24 is a side view of the optical element 100 of Example 3 equipped with the ferrule 200 and the ferrule 220.

### Example 4

The optical element 100 of Example 4 is designed for connection in a single procedure of a multicore optical fiber and used with a MT ferrule (Mechanically Transferable Ferrule) used for connection in a single procedure.

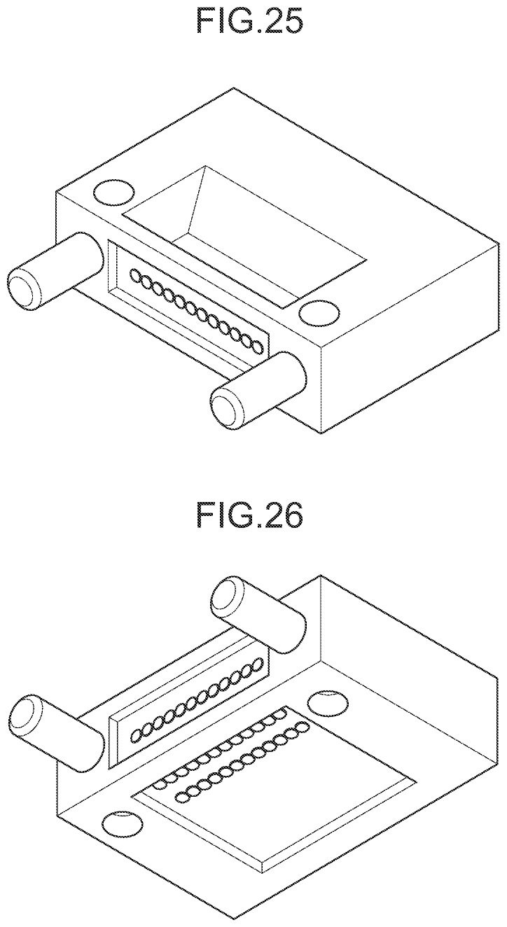

FIG. 25 is a perspective view of the optical element 100 of Example 4 from above.

On a side of the optical element 100, a set of 12 lens surfaces 131 for delivering light is arranged horizontally in a line. The diameter of each lens surface 131 for delivering light is 250 micrometers. The center-to-center spacing between two adjacent lens surfaces 131 for delivering light is 250 micrometers.

FIG. 26 is a perspective view of the optical element 100 of Example 4 from below.

On the bottom of the optical element 100, each of a set of 12 lens surfaces 111 for receiving light and a set of 12 additional lens surfaces LLP is arranged in a line such that the line is parallel to the above-described line of the lens surfaces 111 for receiving light. The diameter of each lens surface 111 for receiving light and each additional lens surface LLP is 250 micrometers. Each of the center-to-center spacing between two adjacent lens surfaces 111 for receiving light and the center-to-center spacing between two adjacent additional lens surfaces LLP is 250 micrometers. One of the additional lens surfaces LLP and one of the lens surfaces 131 for delivering light make a set. The lens surfaces are arranged such that the coordinates in the direction of the above-described lines of the positions of the additional lens surface LLP and the lens surface 131 for delivering light in each set are identical with each other. The center-to-center spacing between the additional lens surface LLP and the lens surface 131 for delivering light in each set is 500 micrometers. One of the lens surfaces 111 for receiving light, one of the lens surfaces 131 for delivering light and one of the additional lens surfaces LLP make a set. The lens surfaces are arranged such that the coordinates in the direction of the above-described lines of the positions of the three lens surfaces in each set are identical with one another. The lens surface 111 for receiving light and the lens surface 131 for delivering light in each set make up an optical system for communication and the additional lens surface LLP in the set makes up an optical system for forming an attenuating area for the above-described optical system for communication.

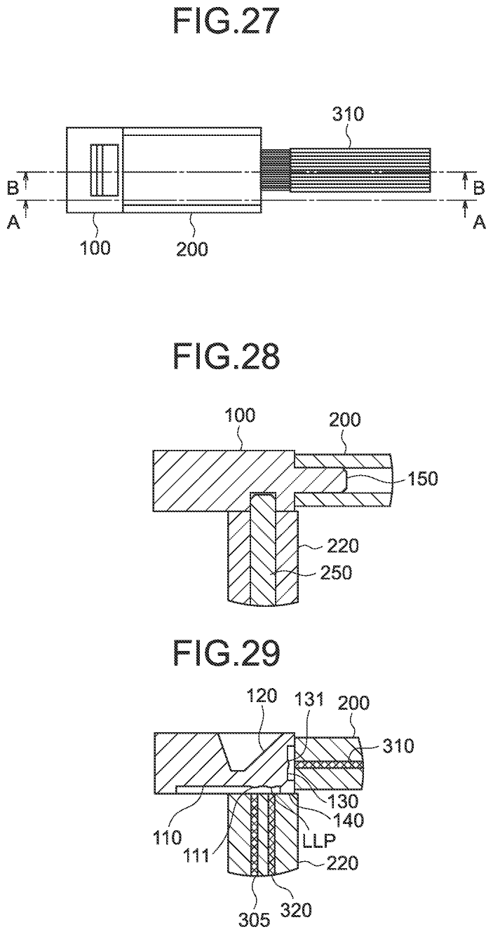

FIG. 27 is a top view of the optical element 100 of Example 4 equipped with a ferrule 200.

FIG. 28 shows the A-A cross section in FIG. 27. As shown in FIG. 28, the ferrule 200 is fixed to the optical element 100 by inserting a pin 150 for fixing a ferrule of the optical element 100 into a hole of the ferrule 200 and a ferrule 220 is fixed to the optical element 100 by a pin 250 for fixing a ferrule. The pin 250 is separate from other elements and is designed to be inserted into a hole of the ferrule 220 as well as a hole of the optical element 100.

FIG. 29 shows the B-B cross section in FIG. 27. The lens surface 111 for receiving light, the lens surface 131 for delivering light and the additional lens surface LLP shown in FIG. 29 are contained in a single set. The lens surface 111 for receiving light receives a light beam from an optical fiber 305 that serves as a light source. The lens surface 131 for delivering light focuses the light beam on the end face of an optical fiber 310 for communication. The additional lens surface LLP receives a laser beam from an optical fiber 320 for processing. The optical fiber 305 and the optical fiber 320 for processing are positioned using a surface 140 for positioning. The surface140 for positioning is parallel to a surface 110 of the optical element 100, on which the lens surface 111 for receiving light and the additional lens surface LLP are provided.

The optical system for communication made up by the lens surface 111 for receiving light and the lens surface 131 for delivering light is identical with that of Example 1. The additional lens surface LLP focuses a laser beam that is incident on the additional lens surface LLP on a point on the path of the ray that passes through the vertex of the lens surface 111 for receiving light and the vertex of the lens surface 131 for delivering light.

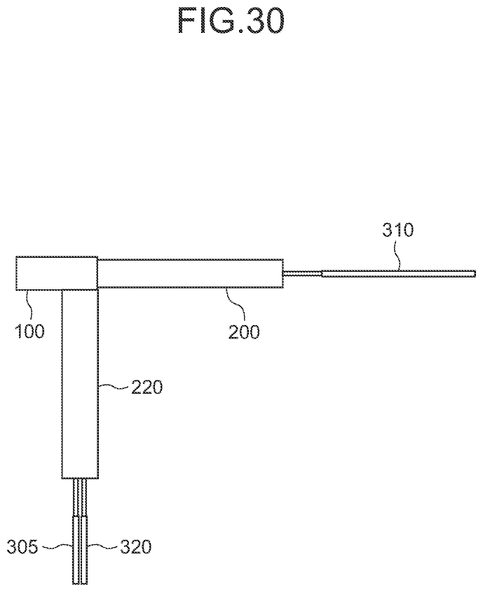

FIG. 30 is a side view of the optical element 100 of Example 4 equipped with the ferrule 200 and the ferrule 220.

### Example 5

The optical element 100 of Example 5 is designed for connection of a single-core optical fiber and used with a LC ferrule for a single-core optical fiber.

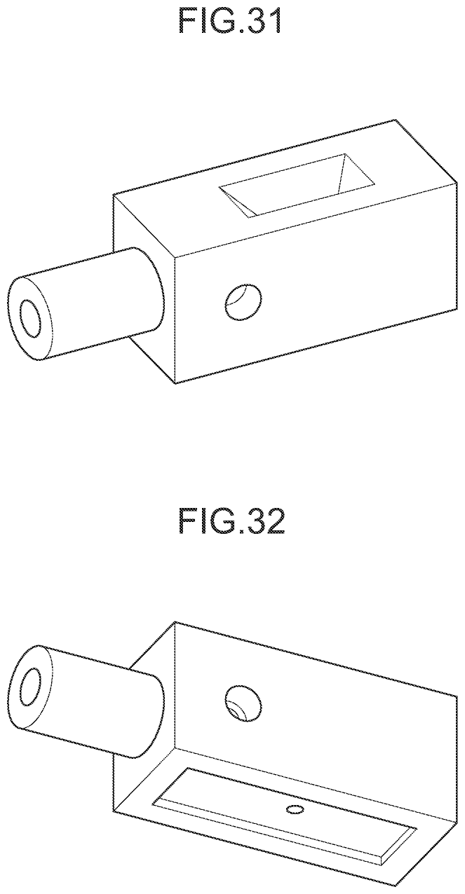

FIG. 31 is a perspective view of the optical element 100 of Example 5 from above.

On a side of the optical element 100, a protruding portion in a cylindrical shape is provided. The protruding portion is positioned such that the central axis of the cylindrical shape passes through the vertex of the lens surface 131 for delivering light. A ferrule for an optical fiber 310 for communication is fit into the cylindrical shape. On another side that is orthogonal to the above-described side of the optical element 100, a socket is provided. The socket is a hole having a circular cross section and is positioned such that the central axis of the circular cross section passes through the vertex of the additional lens surface LLP. A ferrule for an optical fiber 320 for processing is fit into the hole.

FIG. 32 is a perspective view of the optical element 100 of Example 5 from below.

On the bottom of the optical element 100, the lens surface 111 for receiving light is provided.

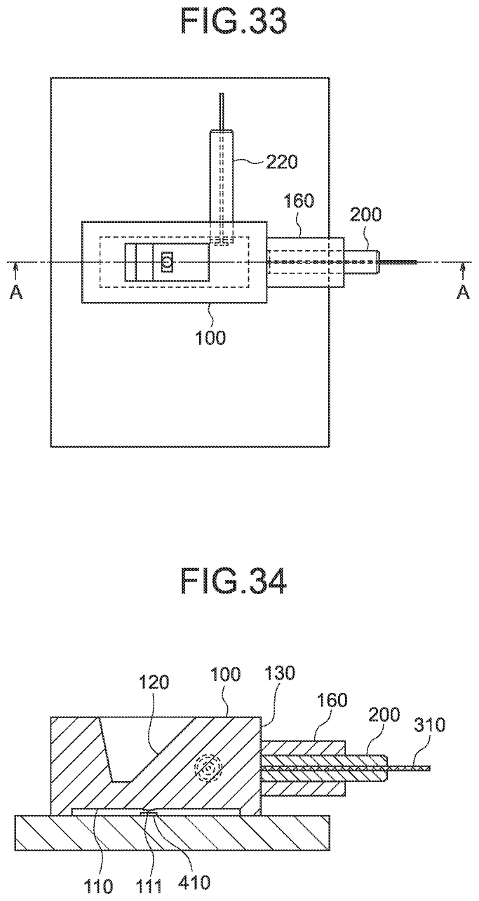

FIG. 33 is a plane cross section of the optical element 100 of Example 5 equipped with a ferrule 200 and a ferrule 220.

FIG. 34 shows the A-A cross section in FIG. 33. In FIG. 34 the optical fiber 310 for communication is aligned with the lens surface 131 for delivering light by fitting the ferrule 200 into the cylindrical shape of the protruding portion 160. A light beam from a light source 410 is incident on the lens surface 111 for receiving light, travels in the optical element 100, is reflected by a surface 120 for total internal reflection and is focused on the end surface of the optical fiber 310 for communication by the lens surface 131 for delivering light. The diameter of each of the lens surface 111 for receiving light and the lens surface 131 for delivering light is 250 micrometers. The optical system for communication made up by the lens surface 111 for receiving light and the lens surface 131 for delivering light is identical with that of Example 1.

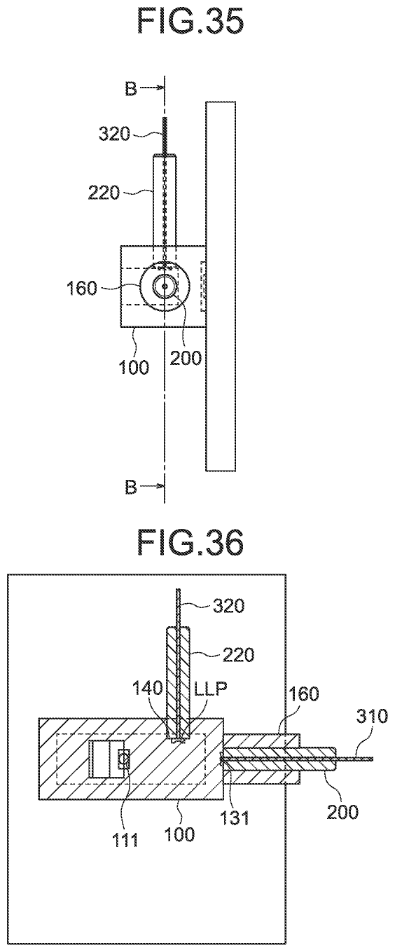

FIG. 35 is a cross section of the optical element 100 of Example 5 equipped with the ferrule 200 and the ferrule 220.

FIG. 36 shows the B-B cross section in FIG. 35. In FIG. 36 the ferrule 200 is fit into the cylindrical shape of the protruding portion 160 on a side of the optical element 100 and the ferrule 220 is fit into a hole on another side of the optical element 100. The optical fiber 310 for communication is aligned with the lens surface 131 for delivering light by the fitting of the ferrule 200 and the optical fiber 320 for processing is aligned with the additional lens surface LLP by the fitting of the ferrule 220. The end face of the ferrule 220 is positioned using a surface 140 for positioning. The surface 140 for positioning is parallel to the surface of the optical element 100, on which the additional lens surface LLP is provided.

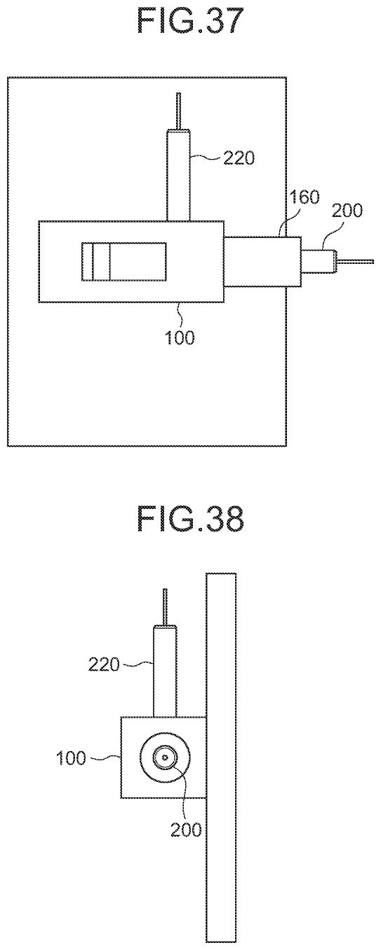

FIG. 37 is a top view of the optical element 100 of Example 5 equipped with the ferrule 200 and the ferrule 220.

FIG. 38 is a side view of the optical element 100 of Example 5 equipped with the ferrule 200 and the ferrule 220.

### Example 6

The optical element 100 of Example 6 is designed for connection in a single procedure of a multicore optical fiber and used with a MT ferrule (Mechanically Transferable Ferrule) used for connection in a single procedure.

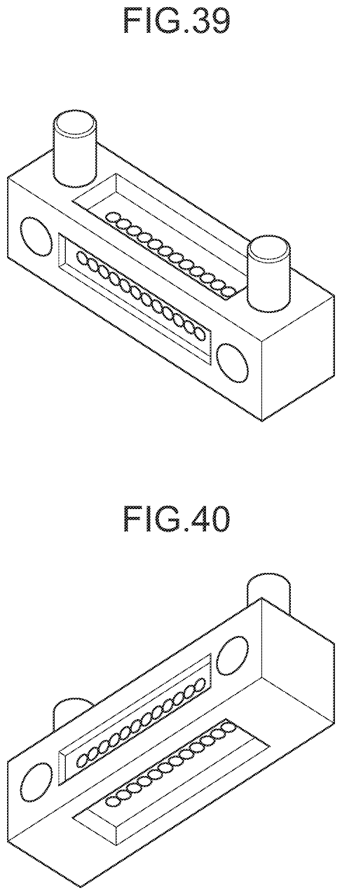

FIG. 39 is a perspective view of the optical element 100 of Example 6 from above.

FIG. 40 is a perspective view of the optical element 100 of Example 6 from below.

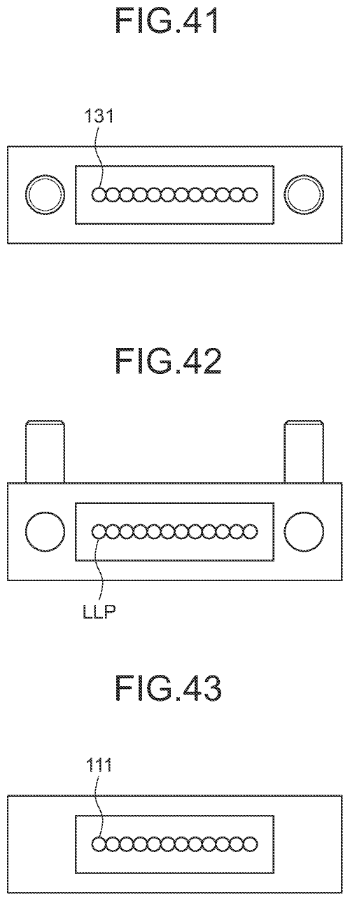

FIG. 41 is a top view of the optical element 100 of Example 6. On the top of the optical element 100, a set of 12 lens surfaces 131 for delivering light is arranged horizontally in a line. The diameter of each lens surface 131 for delivering light is 250 micrometers. The center-to-center spacing between two adjacent lens surfaces 131 for delivering light is 250 micrometers.

FIG. 42 is a side view of the optical element 100 of Example 6. On the side of the optical element 100, a set of 12 additional lens surfaces LLP is arranged in a line such that the line is parallel to the above-described line of the lens surfaces 131 for delivering light. The diameter of each additional lens surface LLP is 250 micrometers. The center-to-center spacing between two adjacent additional lens surfaces LLP is 250 micrometers.

FIG. 43 is a bottom view of the optical element 100 of Example 6. On the bottom of the optical element 100, a set of 12 lens surfaces 111 for receiving light is arranged in a line such that the line is parallel to the above-described line of the lens surfaces 131 for delivering light. The diameter of each lens surface 111 for receiving light is 250 micrometers. The center-to-center spacing between two adjacent lens surfaces 111 for receiving light is 250 micrometers. One of the lens surfaces 111 for receiving light, one of the lens surfaces 131 for delivering light and one of the additional lens surfaces LLP make a set. The lens surfaces are arranged such that the coordinates in the direction of the above-described lines of the positions of the three lens surfaces in each set are identical with one another. The lens surface 111 for receiving light and the lens surface 131 for delivering light in each set make up an optical system for communication and the additional lens surface LLP in the set makes up an optical system for forming an attenuating area for the above-described optical system for communication.

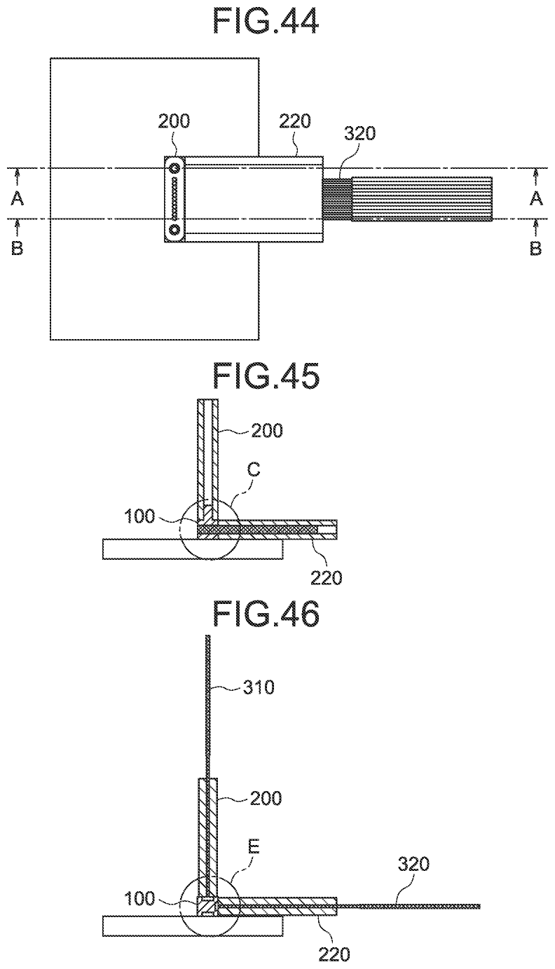

FIG. 44 is a top view of the optical element 100 of Example 5 equipped with a ferrule 200 and a ferrule 220.

FIG. 45 shows the A-A cross section in FIG. 44.

FIG. 46 shows the B-B cross section in FIG. 44.

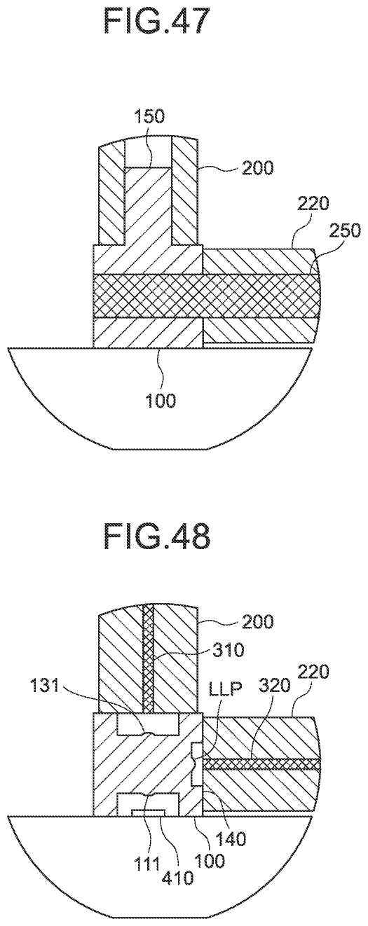

FIG. 47 is an enlarged view of the portion marked with C in FIG. 45. As shown in FIG. 47, the ferrule 200 is fixed to the optical element 100 with a pin 150 for fixing a ferrule provided with the optical element 100 and the ferrule 220 is fixed to the optical element 100 by a pin 250 for fixing a ferrule. The pin 250 is separate from other elements.

FIG. 48 is an enlarged view of the portion marked with E in FIG. 46. As shown in FIG. 48, an optical fiber 310 for communication is aligned with the lens surface 131 for delivering light by the fixing of the ferrule 200 and an optical fiber 320 for processing is aligned with the additional lens surface LLP by the fixing of the ferrule 220. The end face of the ferrule 220 is positioned using a surface 140 for positioning of the optical element 100. The surface 140 for positioning is parallel to the surface of the optical element, on which the additional lens surface LLP is provided. A light beam from a light source 410 is incident on the lens surface 111 for receiving light, travels in the optical element 100 and is focused by the additional lens surface LLP on the end face of the optical fiber 310 for communication by the lens surface 131 for delivering light. A light beam from the optical fiber 320 for processing is focused on a point on the path of the light beam that is incident on the lens surface 111 for receiving light and travels in the optical element 100.

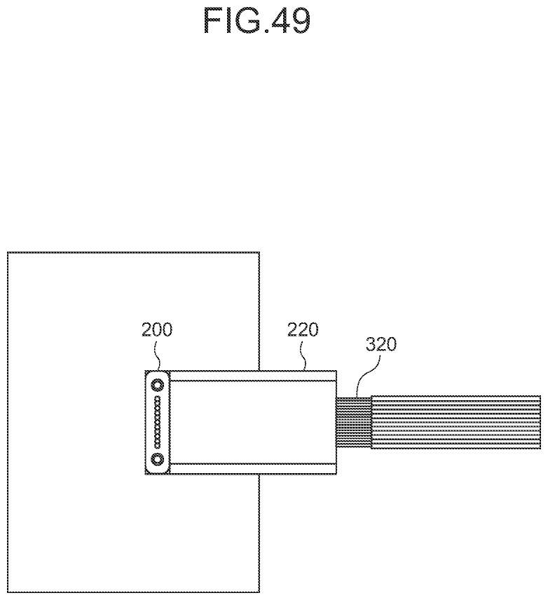

FIG. 49 is a top view of the optical element 100 of Example 6 equipped with the ferrule 200 and the ferrule 220.

### Example 7

The optical element 100 of Example 7 is designed for connection in a single procedure of a multicore optical fiber and used with a MT ferrule (Mechanically Transferable Ferrule) used for connection in a single procedure.

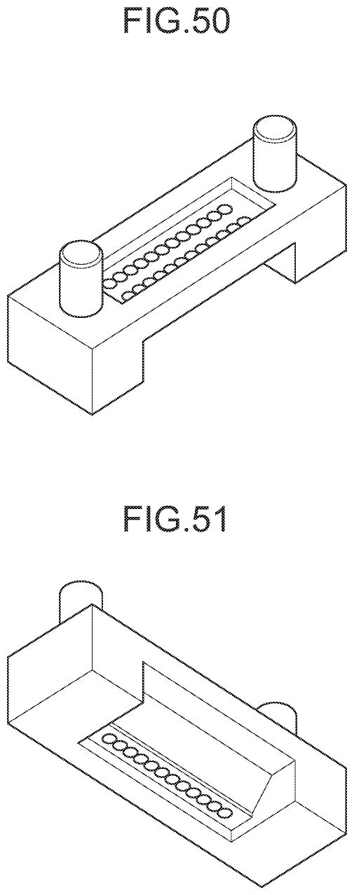

FIG. 50 is a perspective view of the optical element 100 of Example 7 from above.

FIG. 51 is a perspective view of the optical element 100 of Example 7 from below.

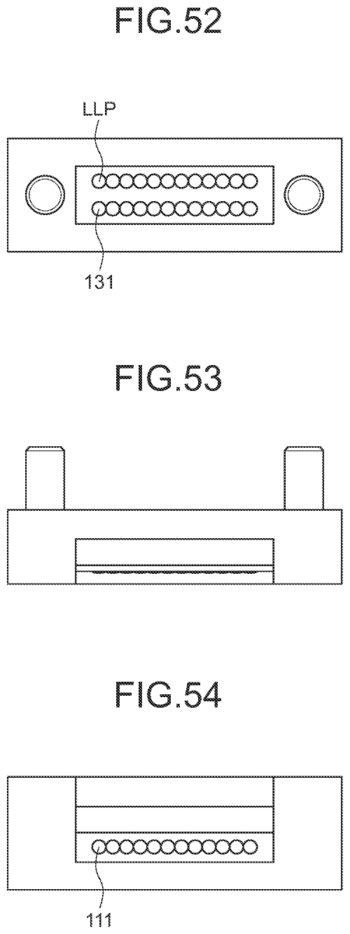

FIG. 52 is a top view of the optical element 100 of Example 7. On the top of the optical element 100, each of a set of 12 lens surfaces 131 for delivering light and a set of 12 additional lens surfaces LLP is arranged in a line. The two lines are parallel to each other. The diameter of each lens surface 131 for delivering light and each additional lens surface LLP is 250 micrometers. Each of the center-to-center spacing between two adjacent lens surfaces 131 for delivering light and the center-to-center spacing between two adjacent additional lens surfaces LLP is 250 micrometers. One of the additional lens surfaces LLP and one of the lens surfaces 131 for delivering light make a set. The lens surfaces are arranged such that the coordinates in the direction of the above-described lines of the positions of the additional lens surface LLP and the lens surface 131 for delivering light in each set are identical with each other. The center-to-center spacing between the additional lens surface LLP and the lens surface 131 for delivering light in each set is 500 micrometers.

FIG. 53 is a side view of the optical element 100 of Example 7.

FIG. 54 is a bottom view of the optical element 100 of Example 7. On the bottom of the optical element 100, a set of 12 lens surfaces 111 for receiving light is arranged in a line. The line is parallel to the above-described line of the lens surfaces 131 for delivering light. The diameter of each lens surface 111 for receiving light is 250 receiving light is 250 micrometers. One of the lens surfaces 111 for receiving light, one of the lens surfaces 131 for delivering light and one of the additional lens surfaces LLP make a set. The lens surfaces are arranged such that the coordinates in the direction of the above-described lines of the positions of the three lens surfaces in each set are identical with one another. The lens surface 111 for receiving light and the lens surface 131 for delivering light in each set make up an optical system for communication and the additional lens surface LLP in the set makes up an optical system for forming an attenuating area for the above-described optical system for communication.

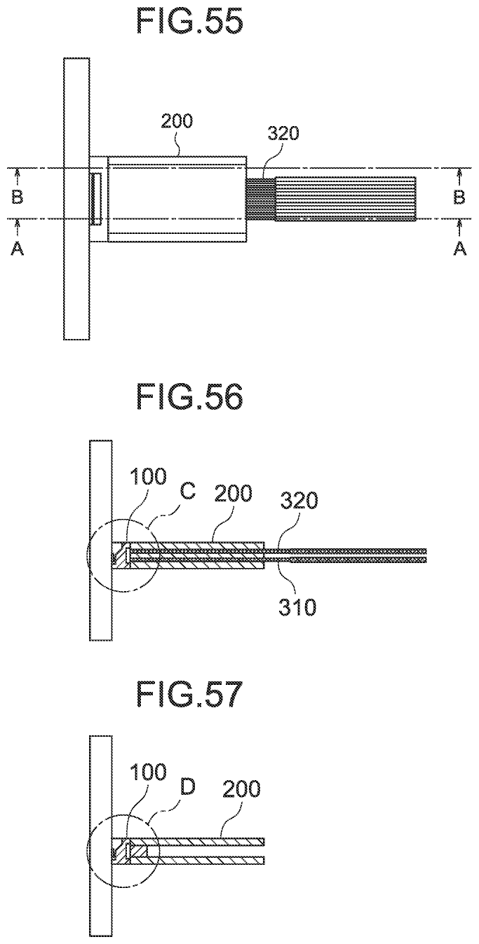

FIG. 55 is a side view of the optical element 100 of Example 7 equipped with a ferrule 200.

FIG. 56 shows the A-A cross section in FIG. 55.

FIG. 57 shows the B-B cross section in FIG. 55. As shown in FIG. 57, the ferrule 200 is fixed to the optical element 100 with a pin for fixing a ferrule provided with the optical element 100.

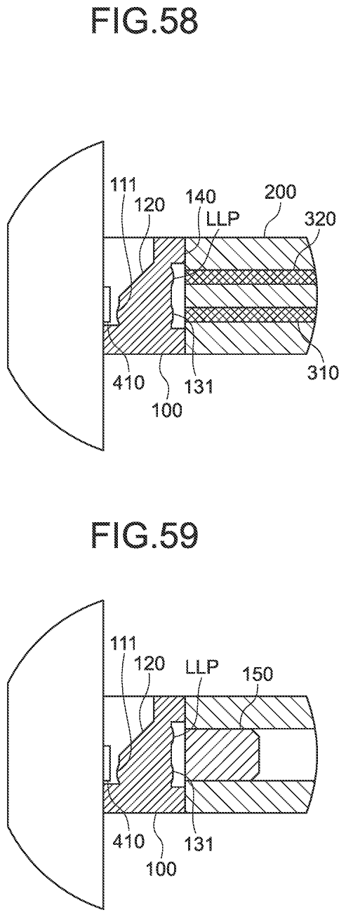

FIG. 58 is an enlarged view of the portion marked with C in FIG. 56. As shown in FIG. 58, an optical fiber 310 for communication is aligned with the lens surface 131 for delivering light and an optical fiber 320 for processing is aligned with the additional lens surface LLP by the fixing of the ferrule 200. The end face of the ferrule 200 is positioned using a surface 140 for positioning of the optical element 100. The surface 140 for positioning is parallel to the surface of the optical element, on which the lens surface 131 for delivering light and the additional lens surface LLP are provided. A light beam from a light source 410 is incident on the lens surface 111 for receiving light, travels in the optical element 100 and is focused on the end surface of an optical fiber 310 for communication by the lens surface 131 for delivering light. A light beam from the optical fiber 320 for processing passes through the additional lens surface LLP, is reflected by a surface 120 and is focused on a point on the path of the light beam that is incident on the lens surface 111 for receiving light and travels in the optical element 100.

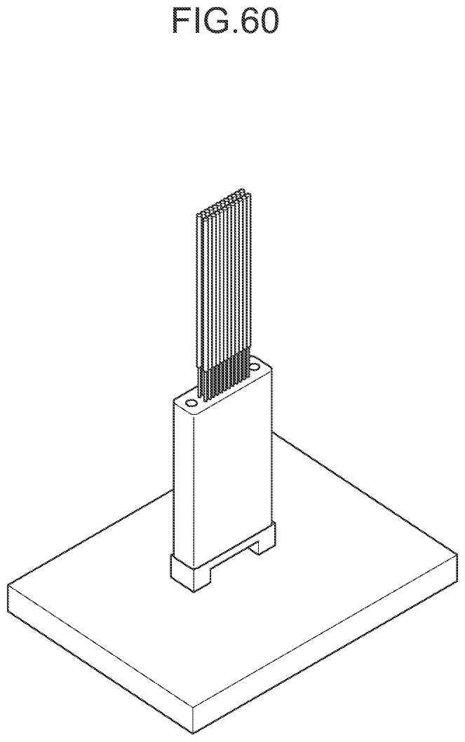

FIG. 59 is an enlarged view of the portion marked with D in FIG. 57. As shown in FIG. 59, the ferrule 200 is fixed to the optical element 100 with a pin 150 for fixing a ferrule provided with the optical element 100.

FIG. 60 is a perspective view of the optical element 100 of Example 7 equipped with the ferrule 200.

### Features of the Optical Element of Each Example

Table 4 shows features of the optical element of each example.

TABLE 4

| | Example | Example | Example | Example | Example | Example | Example |
|---|---|---|---|---|---|---|---|
| | 1 | 2 | 3 | 4 | 5 | 6 | 7 |
| Use | For trans- | For trans- | For | For | For | For | For |
| | mission | mission | trans- | trans- | trans- | trans- | trans- |
| | | | mission | mission | mission | mission | mission |
| Light source for | Laser | Laser | Laser | Fiber | Laser | Laser | Laser |
| communication | | | | | | | |
| used during | | | | | | | |
| measurement | | | | | | | |
| of | | | | | | | |
| transmittance | | | | | | | |
| Surface for | Present | Absent | Absent | Absent | Absent | Absent | Present |
| reflecting laser | | | | | | | |
| beam | | | | | | | |
| Position of | On | On | On top | On | On side | On side | On |
| additional lens | surface on | surface | | surface | | | surface |
| surface for | which | on which | | on which | | | on |
| processing | lens | lens | | lens | | | which |
| | surface for | surface | | surface | | | lens |
| | delivering | for | | for | | | surface |
| | light is | delivering | | receiving | | | for |
| | provided | light is | | light is | | | delivering |
| | (on side) | provided | | provided | | | light |
| | | (on side) | | (on | | | is |
| | | | | bottom) | | | provided |
| | | | | | | | (on side) |
| Ferrule | MT | MT | MT | MT | LC | MT | MT |

In the optical element of each of Examples 1 and 2, the additional lens surface for processing is provided on the surface on which the lens surface for delivering light is provided. Accordingly, a mold part for molding both lens surfaces can be machined as a single part and therefore accuracy in the center-to-center spacing between both lens surfaces can be improved. Further, since a single ferrule can be used for an optical fiber for processing and an optical fiber for communication, a ferrule positioning mechanism can be simplified. As a result, the cost of production can be reduced.

In the optical element of Example 3, the additional lens surface for processing is provided not on a side of the optical element but on the top of the optical element and therefore thickness (height) of the optical element can be reduced.

In the optical element of Example 4, the additional lens surface for processing is provided on the surface on which the lens surface for receiving light is provided. Accordingly, a mold part for molding both lens surfaces can be machined as a single part and therefore accuracy in the center-to-center spacing between both lens surfaces can be improved. Further, since an optical fiber is used as a light source for communication when transmittance is measured during the process of forming an attenuating area, the above-described light source can be easily positioned.

In the optical element of Example 5, the path of a laser beam for forming an attenuating area is parallel to the bottom of the optical element or to the surface of the substrate of the light source for communication and is orthogonal to the path of a light beam for communication. Accordingly, a possibility that an unintended reflected beam travels across the path of a light beam for communication and therefore accuracy in the measurement of transmittance deteriorates can be reduced. Further, the thickness (height) of the optical element used with a ferrule for a single-core optical fiber such as a LC ferrule can be reduced.

The optical element of each of Examples 6 and 7 can be used for an optical fiber running in the direction perpendicular to the bottom of the optical element or the surface of the substrate of the light source for communication.

What is claimed is:

1. An optical element for optically connecting a light source and a light receiving element, the optical element comprising a lens surface for receiving light designed to face the light source, a lens surface for delivering light designed to face the light receiving element and an attenuating area for attenuating a light beam that is incident on the lens surface for receiving light and reaches the lens surface for delivering light,
wherein the optical element further comprises an additional lens surface and a surface for positioning another light source for the additional lens surface and
wherein the additional lens surface is configured such that a conjugate point of an intersection of an optical axis of the additional lens surface with a plane containing the surface for positioning lies on a path of the light beam.

2. The optical element according to claim 1, wherein the attenuating area is an area in which optical properties of material have changed.

3. The optical element according to claim 1, wherein a surface of the optical element, on which the lens surface for receiving light is provided and a surface of the optical element, on which the lens surface for delivering light is provided, are perpendicular to each other and the additional lens surface is provided on the surface of the optical element, on which the lens surface for delivering light is provided.

4. The optical element according to claim 1, wherein a surface of the optical element, on which the lens surface for receiving light is provided and a surface of the optical element, on which the lens surface for delivering light is provided, are perpendicular to each other and the additional lens surface is provided on the surface of the optical element, on which the lens surface for receiving light is provided.

5. The optical element according to claim 1, wherein a surface of the optical element, on which the lens surface for receiving light is provided and a surface of the optical element, on which the lens surface for delivering light is provided, are perpendicular to each other and the additional lens surface is provided on a surface of the optical element other than the surface of the optical element, on which the lens surface for receiving light is provided and the surface of the optical element, on which the lens surface for delivering light is provided.

6. The optical element according to claim 1, wherein a surface of the optical element, on which the lens surface for receiving light is provided and a surface of the optical element, on which the lens surface for delivering light is provided, are parallel to each other and the additional lens surface is provided on a surface of the optical element other than the surface of the optical element, on which the lens surface for receiving light is provided and the surface of the optical element, on which the lens surface for delivering light is provided.

7. The optical element according to claim 1, wherein a surface of the optical element, on which the lens surface for receiving light is provided and a surface of the optical element, on which the lens surface for delivering light is provided, are parallel to each other and the additional lens surface is provided on the surface of the optical element, on which the lens surface for delivering light is provided.

8. The optical element according to claim 1, wherein the surface for positioning is parallel to a surface of the optical element, on which the additional lens surface is provided.

9. The optical element according to claim 1, configured to substantially collimate the light beam that is incident on the lens surface for receiving light and reaches the lens surface for delivering light.

10. The optical element according to claim 1, wherein the optical element is configured for a multicore optical fiber and includes lens surfaces for receiving light arranged in a line, lens surfaces for delivering light arranged in a line, additional lens surfaces arranged in a line, the lines being parallel to one other, and a single surface for positioning plural light sources for the additional lens surfaces,
wherein one of the lens surfaces for receiving light, one of the lens surfaces for delivering light and one of the additional lens surfaces make a set and the lens surfaces are configured such that coordinates in the direction of the lines of positions of the lens surfaces in each set are identical with one another,
wherein for each set an attenuating area for attenuating a light beam that is incident on the lens surface for receiving light and reaches the lens surface for delivering light is provided and
wherein for each set the additional lens surface is configured such that the conjugate point of the intersection of the optical axis of the additional lens surface with a plane containing the surface for positioning lies on a path of the light beam that is incident on the lens surface for receiving light and reaches the lens surface for delivering light.

11. A method of producing an optical element for optically connecting a light source and a light receiving element, the optical element including an attenuating area therein, the method including:
producing an optical element provided with a lens surface for receiving light designed to face the light source, a lens surface for delivering light designed to face the light receiving element and an additional lens surface; and
forming the attenuating area inside the optical element by making a laser beam enter the optical element through the additional lens surface based on observation of intensity of a light beam that is incident on the lens surface for receiving light and delivered by the lens surface for delivering light such that a desired value of transmittance of the optical element for the light beam is realized by the attenuating area.

12. The method of producing an optical element according to claim 11,
wherein the optical element is configured for a multicore optical fiber and includes lens surfaces for receiving light arranged in a line, lens surfaces for delivering light arranged in a line, additional lens surfaces arranged in a line, the lines being parallel to one other, and a single surface for positioning plural light sources for the additional lens surfaces and
wherein one of the lens surfaces for receiving light, one of the lens surfaces for delivering light and one of the additional lens surfaces make a set and the lens surfaces are arranged such that coordinates in the direction of the lines of positions of the lens surfaces in each set are identical with one another.
